(19) United States
(12) Patent Application Publication
(10) Pub. No.: US 2022/0121138 A1
(43) Pub. Date: Apr. 21, 2022

(54) FILTER, FILTER HOLDING DEVICE, DEVELOPING DEVICE, PROCESS CARTRIDGE, AND IMAGE FORMING APPARATUS

(71) Applicants: Tatsumi YAMADA, Kanagawa (JP); Takuya SUGANUMA, Kanagawa (JP); Takuya SEKINE, Kanagawa (JP); Shotaro HOSHI, Kanagawa (JP); Kazuki YOGOSAWA, Tokyo (JP); Yuta YABUTA, Kanagawa (JP); Tatsuya KUBO, Kanagawa (JP); Hotaru HASHIKAWA, Kanagawa (JP)

(72) Inventors: Tatsumi YAMADA, Kanagawa (JP); Takuya SUGANUMA, Kanagawa (JP); Takuya SEKINE, Kanagawa (JP); Shotaro HOSHI, Kanagawa (JP); Kazuki YOGOSAWA, Tokyo (JP); Yuta YABUTA, Kanagawa (JP); Tatsuya KUBO, Kanagawa (JP); Hotaru HASHIKAWA, Kanagawa (JP)

(73) Assignee: Ricoh Company, Ltd.

(21) Appl. No.: 17/498,113

(22) Filed: Oct. 11, 2021

(30) Foreign Application Priority Data
Oct. 16, 2020 (JP) 2020-174707

(51) Int. Cl. G03G 15/08

(52) U.S. Cl. CPC G03G 15/0891; G03G 15/0898; G03G 15/0813

(57) ABSTRACT

A filter includes a sticker and a filter body. The filter body has a smaller weight density per unit volume at a first side than at a second side opposite the first side. The sticker is disposed around a surface of the second side of the filter body.

### CROSS-REFERENCE TO RELATED APPLICATION

This patent application is based on and claims priority pursuant to 35 U.S.C. § 119(a) to Japanese Patent Application No. 2020-174707, filed on Oct. 16, 2020, in the Japan Patent Office, the entire disclosure of which is incorporated by reference herein.

### BACKGROUND

### Technical Field

Embodiments of the present disclosure relate to a filter that collects an object to be collected such as toner for ventilation, a filter holding device provided with the filter, a developing device that accommodates the toner, a process cartridge, and an image forming apparatus.

### Related Art

There is known a technique of disposing a filter in an opening portion formed in an upper part of a developing case in a developing device installed in an image forming apparatus such as a copying machine or a printer, for the purpose of preventing toner scattering due to an increase of an internal pressure in the developing device.

### SUMMARY

In an aspect of the present disclosure, there is provided a filter that includes a sticker and a filter body. The filter body has a smaller weight density per unit volume at a first side than at a second side opposite the first side. The sticker is disposed around a surface of the second side of the filter body.

In another aspect of the present disclosure, there is provided a filter holding device that includes the filter.

In still another aspect of the present disclosure, there is provided a developing device that includes the filter holding device.

In still yet another aspect of the present disclosure, there is provided a process cartridge that includes the developing device.

In still yet further another aspect of the present disclosure, there is provided an image forming apparatus that includes the process cartridge.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a schematic view of an image forming apparatus according to an embodiment of the present disclosure;

FIG. 2 is a cross-sectional view of an image forming unit of the image forming apparatus of FIG. 1;

FIG. 3 is a diagram illustrating a developing device in a longitudinal direction of the image forming apparatus of FIG. 1;

FIG. 4A is an enlarged cross-sectional view of an opening portion of the developing device of FIG. 2 provided with a filter;

FIG. 4B is an enlarged cross-sectional view of the opening portion of the developing device of FIG. 2 before being provided with the filter;

FIG. 5A is a top view of the filter;

FIG. 5B is a side cross-sectional view of the filter;

FIGS. 6A and 6B are schematic enlarged diagrams illustrating states of a ventilation in the opening portion of the developing device;

FIG. 7A is an enlarged cross-sectional view of an opening portion of the developing device of FIG. 2 provided with a filter as a first variation;

FIG. 7B is an enlarged cross-sectional view of the opening portion of the developing device of FIG. 2 before being provided with the filter as the first variation;

FIGS. 8A and 8B are enlarged cross-sectional diagrams illustrating states in which the filter is disposed in the opening portion of the developing device as a second variation; and

FIG. 9 is an enlarged cross-sectional view of an opening portion of the developing device of FIG. 2 provided with a filter as a third variation.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

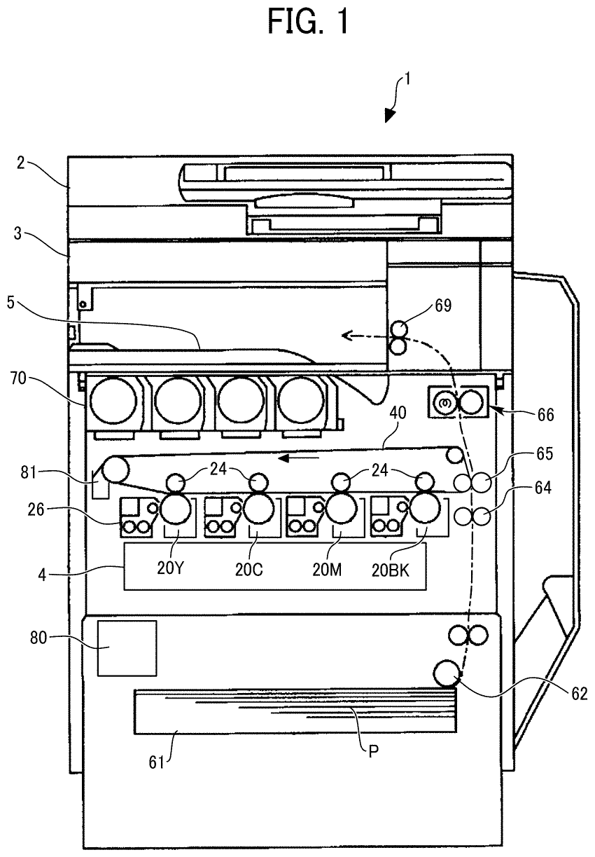

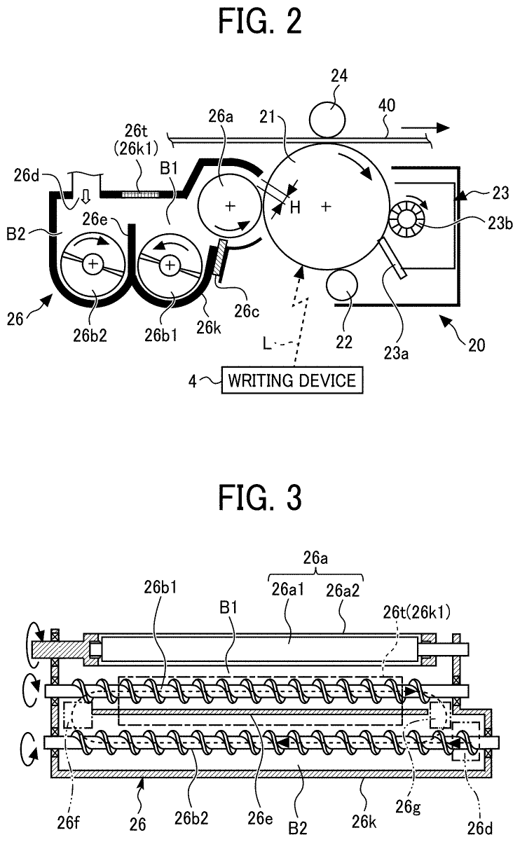

Referring now to FIG. 1, a description is given of an overall configuration and operation of an image forming apparatus 1 according to an embodiment of the present disclosure. The image forming apparatus 1 according to the present embodiment is a tandem multicolor image forming apparatus in which process cartridges 20Y, 20M, 20C, and 20BK are arranged in parallel to each other, facing an intermediate transfer belt 40. A developing device 26 as a filter holding device, which is a device with a filter, is disposed to face a photoconductor drum 21 in each of the process cartridges 20Y, 20M, 20C, and 20BK as illustrated in FIG. 2.

In FIG. 1, the image forming apparatus 1, which is main body of a color copier in the present embodiment, includes a document conveyor 2, a scanner 3 as a document reading device, and a writing device 4 as an exposure device. The document conveyor 2 conveys a document to the scanner 3. The scanner 3 reads image data of the document. The writing device 4 emits a laser beam based on input image data. Yellow, magenta, cyan and black toner images are formed on the surfaces of the photoconductor drums 21 of the process cartridges 20Y, 20M, 20C, and 20BK, respectively. The yellow, magenta, cyan and black toner images on the photoconductor drums 21 are transferred onto the intermediate transfer belt 40 and superimposed. The image forming apparatus 1 further includes a sheet feeder 61, a secondary transfer roller 65, and a fixing device 66. The sheet feeder 61 accommodates sheets P such as paper sheets. The secondary transfer roller 65 transfers the toner image formed on the intermediate transfer belt 40 onto the sheet P. The fixing device 66 fixes an unfixed toner image on the sheet P. The image forming apparatus 1 still further includes toner containers 70, cleaning devices 23, an intermediate transfer belt cleaner 81, and a waste-toner container 80. The toner containers 70 supply toners of respective colors to the developing devices 26 of the corresponding process cartridges 20Y, 20M, 20C, and 20BK. The waste-toner container 80 collects a toner collected by the cleaning devices 23 (see FIG. 2) or an untranferred toner collected by the intermediate transfer belt cleaner 81.

Each of the process cartridges 20Y, 20M, 20C, and 20BK includes the photoconductor drum 21 as an image bearer, a charging device 22, and the cleaning device 23, which are united as a single unit as illustrated in FIG. 2. Each of the process cartridges 20Y, 20M, 20C, and 20BK, which is expendable, is removed from a main body of the image forming apparatus 1 and replaced with a new one when depleted in the main body of the image forming apparatus 1. The developing device 26 is disposed to face the photoconductor drum 21 in each of the process cartridges 20Y, 20M, 20C, and 20BK. Each of the developing devices 26, which is expendable, is removed from a main body of the image forming apparatus 1 and replaced with a new one when depleted in a main body of the image forming apparatus 1. An operator may independently perform an installation and a removal operation of the developing device 26 with respect to the main body of the image forming apparatus 1, and an installation and a removal operation of the process cartridges 20Y, 20M, 20C, and 20BK with respect to the main body of the image forming apparatus 1, as different operations. In the process cartridges 20Y, 20M, 20C, and 20BK, the yellow, magenta, cyan, and black toner images are formed on the respective photoconductor drums 21 as the image bearers.

A description is provided below of operations of the image forming apparatus 1 to form a normal color toner image. A conveyance roller of the document conveyor 2 conveys a document from a document table onto an exposure glass of the scanner 3. The scanner 3 optically scans image data for the document on the exposure glass. The yellow, magenta, cyan, and black image data are transmitted to the writing device 4. The writing device 4 irradiates the surface of the photoconductor drums 21 (see FIG. 2) of the corresponding process cartridges 20Y, 20M, 20C, and 20BK with laser beams (as exposure light) L according to the yellow, magenta, cyan, and black image data, respectively.

Each of the four photoconductor drums 21 rotates clockwise in FIGS. 1 and 2. The surface of the photoconductor drum 21 is uniformly charged at a position where the photoconductor drum 21 faces the charging device 22 that is a charging roller (in a charging process). Thus, the surface of the photoconductor drum 21 is charged to a certain potential. When the charged surface of the photoconductor drum 21 reaches a position to receive the laser beam L emitted from the writing device 4, an electrostatic latent image is formed on the surface of the photoconductor drum 21 according to the image data (in an exposure process).

The laser beam L corresponding to a yellow image data is emitted to the surface of photoconductor drum 21 in the process cartridge 20Y, which is the first from the left in FIG. 1 among the four process cartridges 20Y, 20M, 20C, and 20BK. A polygon mirror that rotates at high velocity deflects the laser beam L for the yellow image data so that the laser beam L scans the surface of the photoconductor drum 21 along an axial direction of the photoconductor drum 21 (i.e., the main scanning direction). Thus, an electrostatic latent image corresponding to the yellow image data is formed on the photoconductor drum 21 charged by the charging device 22. Similarly, the laser beam L corresponding to the cyan image data is emitted to the surface of the photoconductor drum 21 in the second process cartridge 20C from the left in FIG. 1, thus forming an electrostatic latent image for cyan on the surface of the photoconductor drum 21. The laser beam L corresponding to the magenta image data is emitted to the surface of the photoconductor drum 21 in the third process cartridge 20M from the left in FIG. 1, thus forming an electrostatic latent image for magenta on the surface of the photoconductor drum 21. The laser beam L corresponding to the black image data is irradiated to the surface of the photoconductor drum 21 in the fourth process cartridge 20BK from the left in FIG. 1, thus forming an electrostatic latent image for black on the photoconductor drum 21.

Then, the surface of the photoconductor drum 21 bearing the electrostatic latent image reaches a position facing the developing device 26. The developing device 26 supplies toner onto the surface of the photoconductor drum 21 and develops the electrostatic latent image on the photoconductor drum 21 into a toner image (in a development process). Subsequently, the surface of the photoconductor drum 21 after a development process reaches a position facing the intermediate transfer belt 40. Each of primary transfer rollers 24 is disposed at the position where the photoconductor drum 21 faces the intermediate transfer belt 40 such that the primary transfer roller 24 contacts an inner circumferential surface of the intermediate transfer belt 40. At the positions of the primary transfer rollers 24, the toner images on the photoconductor drums 21 are sequentially transferred to and superimposed on the intermediate transfer belt 40, forming a multicolor toner image thereon (in a primary transfer process).

After the primary transfer process, the surface of the photoconductor drum 21 reaches a position facing the cleaning device 23. The cleaning device 23 collects untransferred toner remaining on the photoconductor drum 21 (in a cleaning process). The untransferred toner collected in the cleaning device 23 passes through a waste-toner conveyance path and is collected as waste toner in the waste-toner container 80. Subsequently, a residual potential of the surface of the photoconductor drum 21 is removed at a position facing a discharger. Thus, a series of image forming processes performed on the photoconductor drum 21 is completed.

Meanwhile, the surface of the intermediate transfer belt 40, onto which the single-color toner images on the photoconductor drums 21 are transferred and superimposed, moves in a direction indicated by arrow in FIG. 1 and reaches a position facing the secondary transfer roller 65. The secondary transfer roller 65 secondarily transfers the multicolor toner image on the intermediate transfer belt 40 onto the sheet P (in a secondary transfer process). After the secondary transfer process, the surface of the intermediate transfer belt 40 reaches a position facing an intermediate transfer belt cleaner 81. The intermediate transfer belt cleaner 81 collects the untransferred toner on the intermediate transfer belt 40 to complete a series of transfer processes on the intermediate transfer belt 40. The untransferred toner collected in the intermediate transfer belt cleaner 81 passes through the waste-toner conveyance path and is collected as waste toner in the waste-toner container 80.

The sheet P is conveyed from the sheet feeder 61 to the position of the secondary transfer roller 65 via a registration roller pair 64. Specifically, a feed roller 62 feeds the sheet P from the top of multiple sheets P accommodated in the sheet feeder 61. The sheet P is conveyed to the registration roller pair 64 through a sheet conveyance path. Activation of the registration roller pair 64 is timed to convey the sheet P that has reached the registration roller pair 64 toward the position of the secondary transfer roller 65 such that the sheet P meets the multicolor toner image on the intermediate transfer belt 40 at an area of contact, herein called a secondary transfer nip, between the secondary transfer roller 65 and the intermediate transfer belt 40.

Subsequently, the sheet P, onto which the multicolor image is transferred, is conveyed to the fixing device 66. The fixing device 66 includes a fixing roller and a pressure roller pressed against the fixing roller. In an area of contact, herein called a fixing nip, between the fixing roller and the pressure roller, the multicolor toner image is fixed on the sheet P. After the fixing process, an output roller pair 69 ejects the sheet P as an output image outside the main body of the image forming apparatus 1. The ejected sheet P is stacked on an output tray 5 to complete a series of image forming processes.

Next, with reference to FIGS. 2 and 3, image forming units of the image forming apparatus are described in detail below. The four image forming units disposed in the main body of the image forming apparatus 1 have a similar configuration except the color of the toner used in the image forming processes. Therefore, parts of the image forming unit such as the process cartridge and the developing device are illustrated without suffixes Y, M, C, and BK, which denote the colors of the toner, in the drawings.

As illustrated in FIG. 2, the process cartridge 20 mainly includes the photoconductor drum 21 as the image bearer, the charging device 22, and the cleaning device 23, which are stored in a case of the process cartridge 20 as a single unit. The photoconductor drum 21 is an organic photoconductor designed to be charged with a negative polarity and includes a photosensitive layer formed on a drum-shaped conductive support. The charging device 22 is a charging roller including a conductive core and an elastic layer of moderate resistivity overlaid on the conductive core. A power supply applies a given voltage to the charging device 22 (as a charging roller). The charging device 22 uniformly charges the surface of the photoconductor drum 21 facing the charging device 22. The cleaning device 23 includes a cleaning blade 23a and a cleaning roller 23b that contact the photoconductor drum 21. For example, the cleaning blade 23a is made of rubber, such as urethane rubber, and contacts the surface of the photoconductor drum 21 at a predetermined angle with a predetermined pressure. The cleaning roller 23b is a brush roller in which brush bristles are disposed around a core.

As illustrated in FIGS. 2 and 3, the developing device 26 mainly includes a developing roller 26a as a developer bearer, a first conveying screw 26b1 as a first conveyor facing the developing roller 26a, a partition 26e, a second conveying screw 26b2 as a second conveyor facing the first conveying screw 26b1 via the partition 26e, and a doctor blade 26c as a developer regulator facing the developing roller 26a to regulate an amount of developer borne on the developing roller 26a. The developing device 26 in the present embodiment also functions as a filter holding device that holds a filter 26t (as a toner filter). A detailed description of the developing device 26 serving as a filter holding device is deferred.

The developing device 26 stores a two-component developer including carrier and toner. The developing roller 26a faces the photoconductor drum 21 with a small gap, thereby forming a developing range. As illustrated in FIG. 3, the developing roller 26a includes a stationary magnet 26a1 secured inside and a sleeve 26a2 that rotates around the magnets 26a1. The magnet 26a1 generates multiple magnetic poles around an outer circumferential surface of the developing roller 26a.

The first conveying screw 26b1 and the second conveying screw 26b2 as conveyors convey the developer stored in the developing device 26 in a longitudinal direction of the developing device 26, thereby establishing a circulation path indicated by the dashed arrow in FIG. 3. In other words, the first conveying screw 26b1 establishes a first conveyance path B1, whereas the second conveying screw 26b2 establishes a second conveyance path B2. The circulation path of the developer includes the first conveyance path B1 and the second conveyance path B2. The partition 26e is an inner wall and separates the first conveyance path B1 from the second conveyance path B2. The first conveyance path B1 and the second conveyance path B2 communicate with each other via a first communication opening 26f and a second communication opening 26g disposed at both longitudinal ends of the first conveyance path B1 and the second conveyance path B2. Specifically, with reference to FIG. 3, in a conveyance direction of the developer, an upstream end of the first conveyance path B1 communicates with a downstream end of the second conveyance path B2 via the first communication opening 26f On the other hand, in the conveyance direction of the developer, a downstream end of the first conveyance path B1 communicates with an upstream end of the second conveyance path B2 via the second communication opening 26g. That is, the partition 26e is disposed along the circulation path except the both longitudinal ends of the circulation path. The first conveying screw 26b1 (or the first conveyance path B1) is disposed facing the developing roller 26a. The second conveying screw 26b2 (or the second conveyance path B2) is disposed facing the first conveying screw 26b1 (or the first conveyance path B1) via the partition 26e. The first conveying screw 26b1 supplies developer toward the developing roller 26a and collects the developer separated from the developing roller 26a after the development process while conveying the developer in the longitudinal direction of the developing device 26. The second conveying screw 26b2 stirs and mixes the developer after the development process conveyed from the first conveyance path B1 with a fresh toner supplied from a toner supply inlet 26d while conveying the developer and the fresh toner in the longitudinal direction of the developing device 26. In the present embodiment, the two conveying screws (i.e., the first conveying screw 26b1 and the second conveying screw 26b2) are horizontally arranged in parallel. Each of the two conveying screws (i.e., the first conveying screw 26b1 and the second conveying screw 26b2) includes a shaft and a screw blade wound around the shaft.

Referring now to FIGS. 2 and 3, a detailed description is given of the image forming process described above, focusing on the development process. The developing roller 26a rotates in a direction indicated by arrow in FIG. 2. As illustrated in FIGS. 2 and 3, the first conveying screw 26b1 and the second conveying screw 26b2 are disposed facing each other with the partition 26e interposed therebetween and rotate in directions indicated by arrows in FIGS. 2 and 3. Toner is supplied from the toner container 70 to the toner supply inlet 26d via a toner supply path. As the first conveying screw 26b1 and the second conveying screw 26b2 rotate in the respective directions in FIG. 2, the developer stored in the developing device 26 circulates together with the supplied toner in the longitudinal direction of the developing device 26 (i.e., the direction indicated by the dashed arrow in FIG. 3) while being stirred and mixed with the supplied toner. Stirring the developer causes the toner to be charged by friction with carrier in the developer and electrostatically attracted to the carrier. A magnetic force is generated on the developing roller 26a to scoop up the carrier. The magnetic force that is called as a developer scooping pole scoops up the carrier with the toner on the developing roller 26a. The developer borne on the developing roller 26a is conveyed in the counterclockwise direction indicated by arrow in FIG. 2 to a position facing the doctor blade 26c. The doctor blade 26c adjusts the amount of the developer on the developing roller 26a to a proper amount at the position. Subsequently, the rotation of the sleeve 26a2 conveys the developer to the developing area in which the developing roller 26a faces the photoconductor drum 21. The toner in the developer is attracted to the electrostatic latent image formed on the photoconductor drum 21 due to the effect of an electric field generated in the developing area. Thereafter, as the sleeve 26a2 rotates, the developer remaining on the developing roller 26a reaches above the first conveyance path B1 and is separated from the developing roller 26a. The electric field in the developing area is generated by a predetermined voltage (in other words, a development bias) applied to the developing roller 26a by a development power supply and a surface potential (in other words, a latent image potential) formed on the photoconductor drum 21 in the charging process and the exposure process.

The toner in the toner container 70 is supplied as appropriate from the toner supply inlet 26d to the developing device 26 via the toner supply path as the toner in the developing device 26 is consumed. The toner consumption in the developing device 26 is detected by a toner concentration sensor that magnetically detects a toner concentration in the developer (i.e., a ratio of toner to the developer) in the developing device 26. The toner supply inlet 26d is disposed above an end of the second conveying screw 26b2 (or the second conveyance path B2) in a longitudinal direction of the second conveying screw 26b2 (i.e., a lateral direction in FIG. 3).

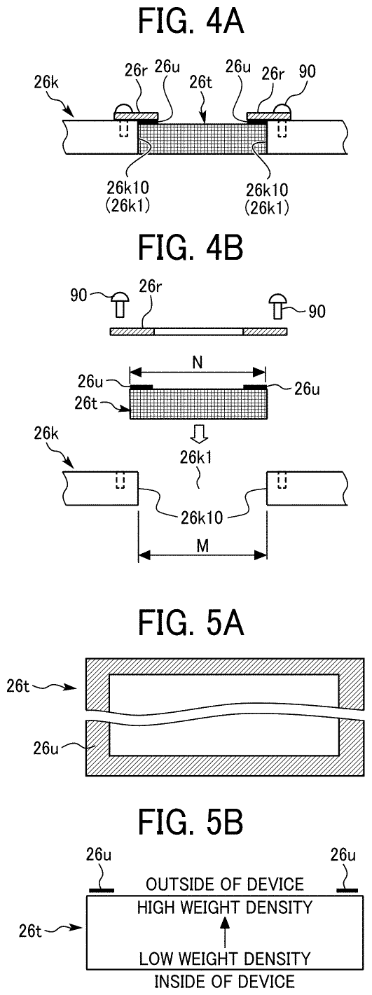

A detailed description is now given of the filter 26t and the developing device 26 as the filter holding device according to the present embodiment. With reference to FIGS. 2 and 4A, the developing device 26 in the present embodiment functions as the filter holding device in which the filter 26t is disposed in an opening portion 26k1 as a communication port between the inside and the outside of the developing device 26. In FIG. 4A, above a developing case 26k is the outside of the developing device 26. Below the developing case 26k is the inside of the developing device 26. Specifically, the opening portion 26k1 (as a ventilation path) through which air passes from the inside to the outside the developing device 26 is formed on the ceiling of the developing case 26k (as a housing) of the developing device 26. The filter 26t is disposed so as to close the opening portion 26k1. The filter 26t collects toner as powder and ventilates the developing device 26. In other words, the opening portion 26k1 (as a ventilation path) through which air passes in a ventilation direction from the inside to the outside of the developing device 26 is formed in the developing case 26k. The filter 26t is disposed in the opening portion 26k1 as a mounting portion. The filter 26t is a screen having a mesh size smaller than the particle diameters of toner T and carrier C and thus allows only air to pass through. The filter is not limited to the above described one, but may be a fiber filter that has a good property to collect toner T. In the present embodiment, the opening portion 26k1 is open in a substantially rectangular shape. The filter 26t (which is in a single state) is formed in a substantially rectangular shape. Shapes of the opening portion 26k1 and the filter 26t are not limited to the shapes described in the present embodiment. The shape of a ring-shaped sticker 26u described later matches the shape of a ventilation face of the filter 26t. For example, in a case in which the ventilation face of the filter 26t is circular, the ring-shaped sticker 26u is circular.

A casing gap H is formed between the developing roller 26a and the developing case 26k downstream from the development area in the direction of rotation of the developing roller 26a. The casing gap H is set to be within a range of 0.6 mm to 1.0 mm. Note that, if the casing gap H is smaller than 0.6 mm, the developer borne on the developing roller 26a after the development process may not smoothly conveyed through the casing gap H between the developing roller 26a and the developing case 26k, causing the developer to overflow from the casing gap H and to leak to the outside of the developing device 26. On the other hand, if the casing gap H is larger than 1.0 mm, the developer borne on the developing roller 26a is not likely to be in sliding contact with the inner surface of the developing case 26k, hardly generating a suction airflow toward the inside of the developing device 26 due to a pump action. As a result, toner is likely to scatter to the development area. To prevent such a situation, with the casing gap H kept within an appropriate range, a leakage of the developer and toner scattering is reduced. The internal pressure of the developing device 26 is likely to increase due to the suction airflow through the casing gap H described above. If the internal pressure increases, the toner may scatter from gaps of the developing device 26. To address such a situation, in the present embodiment, since the opening portion 26k1 provided with the filter 26t is provided to collect the toner T, only air is ventilated while preventing the toner T from scattering to the outside. As a result, the increase of the internal pressure of the developing device 26 is reduced. That is, this configuration inhibits the toner scattering caused by the increase of the internal pressure of the developing device 26.

In the present embodiment, the filter 26t (serving as a filter body) has a lower weight density per unit volume at a first side in the ventilation direction (i.e., a lower side of the filter 26t of FIG. 4A), than at a second side in the ventilation direction (i.e., an upper side of the filter 26t of FIG. 4A). That is, the filter 26t has an uneven weight density per unit volume. The filter 26t has a portion having a relatively low weight density and a portion having a relatively high weight density in a ventilation direction, which may be referred to as a communication direction or a discharge direction. In other words, the filter 26t has a gradient of the weight density per unit volume.

Specifically, as illustrated in FIG. 5B, the filter 26t of the present embodiment has a single-layer structure in which the weight density per unit volume of the filter 26t gradually increases in a direction indicated by arrow in FIG. 5B from the first side (adjacent to the inside of the developing device 26) of the filter 26t to the second side (adjacent to the outside of the developing device 26) of the filter 26t. In short, the filter 26t has a weight density per unit volume gradually increasing along the ventilation direction, which may be referred to as an exhaust direction. Specifically, the filter 26t illustrated in FIG. 5B is coarse and relatively fluffy at the first side, from which the filter 26t is gradually denser toward the second side. The filter 26t in the present embodiment gradually increases a toner collecting force along the ventilation direction. The filter 26t is used such that the first side (i.e., the lower side of the filter 26t in FIG. 4A) is located upstream in the ventilation direction from the second side (i.e., the upper side of the filter 26t in FIG. 4A).

In the developing device 26 of the present embodiment, the opening portion 26k1 has a rim 26k10 (as a wall portion) extending in a direction in which the air flows from the inside of the developing device 26 to the outside of the developing device 26. The direction is the communication direction (i.e., the ventilation direction) and a vertical direction in FIGS. 2 and 4A. The filter 26t is fitted to the rim 26k10 (in the opening portion 26k1) such that the first side (i.e., the side having a relatively low weight density) is located adjacent to the inside of the developing device 26 (i.e., as the lower side of the filter 26t in FIG. 4A), whereas the second side (i.e., the side having a relatively high weight density) is located adjacent to the outside of the developing device 26 (i.e., as the upper side of the filter 26t in FIG. 4A). Further, the filter 26t is disposed in the opening portion 26k1 such that each side face serving as a non-ventilated face (i.e., a face through which air does not flow) of the filter 26t is in contact with the rim 26k10. FIG. 4A two-dimensionally illustrates the filter 26t disposed in (or fitted to) the opening portion 26k1 such that the filter 26t is in contact with the rim 26k10. However, in reality, the filter 26t is disposed in the opening portion 26k1 such that the four side faces of the filter 26t are in contact with the substantially rectangular rim 26k10.

In the present embodiment, when the filter 26t is in a single state in which the filter 26t is not disposed in the opening portion 26k1 (i.e., a state in which the filter 26t does not receive an external force as illustrated in FIG. 4B), the filter 26t has a lower weight density per unit volume at the first side in the ventilation direction (i.e., a lower side of the filter 26t of FIG. 4B) than at the second side in the ventilation direction (i.e., an upper side of the filter 26t of FIG. 4B), i.e., a gradient of weight density is formed. Specifically, when the filter 26t is not disposed in the opening portion 26k1, a length N of the filter 26t in a direction intersecting the ventilation direction is set to be larger than an opening width M, which is a length of the opening portion 26k1 in the direction intersecting the ventilation direction (N>M). As illustrated in FIG. 4A, the filter 26t is disposed in close contact with the opening portion 26k1 while being compressed conforming to the shape of the opening portion 26k1. Note that, even when the filter 26t is disposed in the opening portion 26k1, the gradient relationship in weight density from the first side to the second side of the filter 26t is maintained.

Referring to FIGS. 4A, 4B, 5A, and 5B, in the present embodiment, the ring-shaped sticker 26u attachable to a stopper 26r (serving as a pressing member and a stuck member) is disposed around the surface of the second side (i.e., an upper face in the longitudinal direction in FIGS. 4A, 4B, and 5B, a face illustrated by hatching in FIG. 5A, and the ventilation face) of the filter 26t. Specifically, the sticker 26u may be a double-sided tape or an adhesive to be stuck on the stopper 26r without a gap (without passing air) between the sticker 26u and the stopper 26r. The sticker 26u is disposed on the upper face of the filter 26t (i.e., the ventilation surface on the side having the high-weight density) in a square ring shaped along an outer edge of the upper face of the filter 26t so as to surround a rectangular area in a central portion of the upper face of the filter 26t from all sides. Thus, the upper face of the filter 26t is a face that is substantially breathable (exhaustible) only in the rectangular area in the central portion of the upper face surrounded by the sticker 26u.

Here, the stopper 26r as the stuck member is an air-impermeable member made of, e.g., a metal material or a molded resin material. And the stopper 26r is a plate having an opening inside so as not to interfere with the function (ventilation) of the filter 26t. The sticker 26u of the filter 26t is stuck to an edge of the opening of the stopper 26r.

The stopper 26r (as the stuck member) is detachably attached onto the developing device 26 (as a filter holding device) so that the filter 26t does not come off from the opening portion 26k1 to the outside of the developing device 26. The filter 26t is detachably attached from the outside of the developing device 26. Specifically, when the filter 26t is attached, as illustrated in FIG. 4B, the filter 26t is moved from above the developing device 26 (the opening portion 26k1) in a direction indicated by the white arrow in FIG. 4B. As illustrated in FIG. 4A, the filter 26t is fitted into the opening portion 26k1. In order to prevent the filter 26t from coming off upward, the stopper 26r is fixed (screw-fastened) onto the developing case 26k by screws 90 so as to press the filter 26t from above. In the present embodiment, a plate-shaped member having the opening inside is used as the stopper 26r. The stopper 26r is not limited to this as long as impairing the function of the filter 26t. The stopper 26r is not limited to such a plate-shaped member having the opening inside as long as the stopper 26r does not impair the function of the filter 26t and to which the filter 26t is attached via the sticker 26u. As the stopper 26r, for example, a mesh-shaped member having a coarse mesh in the opening inside may also be used. Further, in order to prevent toner from scattering from a gap between the stopper 26r and the developing case 26k, the stopper 26r is preferably disposed on the developing case 26k via a seal made of, e.g., foamed polyurethane.

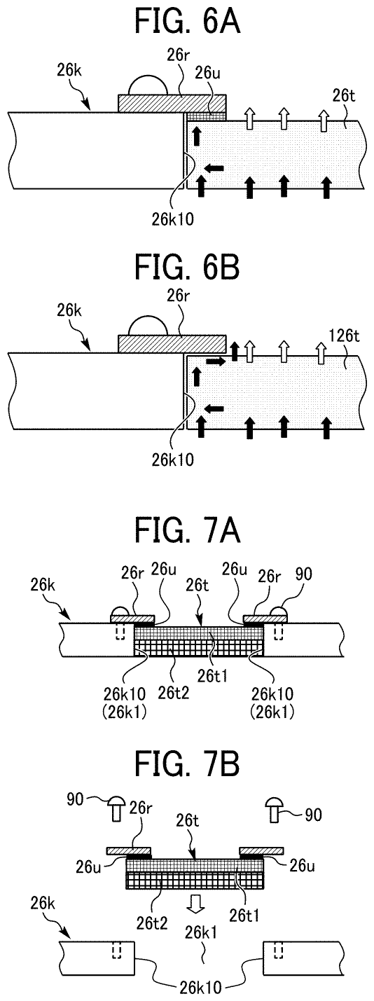

As described above, the filter 26t in the present embodiment is provided with the sticker 26u on the ventilation face of the second side (i.e., the side having the higher weight density) in the ventilation direction, to prevent the gap between the filter 26t and the stopper 26r. The defect that the air (discharge object) in the developing device 26 leaks together with the toner (collection object) from the side of the filter 26t (between the filter 26t and the opening portion 26k1) is reduced. Since the function of the filter 26t described above is fully performed, the toner (collection object) scattering to the outside of the developing device 26 is reduced. Specifically, the filter 26t has a portion having a relatively low weight density per unit volume and a relatively weak adhesion to the rim 26k10. The air easily leaks from the portion together with the toner. For example, if a filter is not provided with the sticker 26u, such as a filter 126t illustrated in FIG. 6B as a comparative example, the toner in the developing device 26 is discharged together with the air to the outside of the developing device 26 from a side (a portion having relatively weak adhesion) of the filter 126t via a gap between the stopper 26r and the filter 126t (in a direction indicated by the black arrow in FIG. 6B). By contrast, in the present embodiment, as illustrated in FIG. 6A, the sticker 26u closes the gap between the stopper 26r and the filter 26t, thus blocking the path (in the direction indicated by the black arrow in FIG. 6A) through which the toner is discharged together with air to the outside of the developing device 26. The filter 26t collects the toner and therefore only the air is discharged to the outside of the developing device 26 (in the direction indicated by the white arrow in FIG. 6A). In the present embodiment, the filter 26t having a weight density increasing in the ventilation direction (i.e., the communication direction) facilitates the air flow from the inside of the developing device 26 to the outside of the developing device 26. With such a configuration, the increase of the internal pressure in the developing device 26 is efficiently restrained. The overall toner collection property of the filter 26t is enhanced while the filter 26t is less likely to be clogged.

In order to address the unfavorable situations as described above, the filter 26t of the present embodiment may be provided with a sticker on the ventilation face of the first side of the filter 26t (i.e., the side having a low weight density) in the ventilation direction, instead of the second side (i.e., the side having a high weight density) of the filter 26t in the ventilation direction, to be stuck on the stuck member (e.g., a portion of the developing case 26k) to prevent formation of a gap between the filter 26t and the stuck member. However, in this case, it is not possible to completely prevent the air from flowing together with the toner from the side face of the first side (i.e., the side having the low weight density) of the filter 26t in the ventilation direction. In other words, it is not possible to completely prevent the air flow in the direction indicated by the black arrow in FIG. 6B. In order to prevent formation of the gap between the filter 26t and the stuck member, the sticker 26u is disposed on the ventilation face of the second side (i.e., the side having a high weight density) of the filter 26t in the ventilation direction and stuck to the stuck member.

First Variation

As illustrated in FIGS. 7A and 7B, in the developing device 26 in the first variation, the filter 26t does not have a one-layer structure. Instead, the filter 26t has a two-layer structure including a low-density portion 26t2 having a relatively low weight density per unit volume at the first side of the filter 26t in the ventilation direction (as a lower side of the filter 26t in FIG. and a high-density portion 26t1 having a relatively high weight density per unit volume at the second side of the filter 26t in the ventilation direction (as an upper side of the filter 26t in FIG. 7). That is, the low-density portion 26t2 at the first side of the filter 26t has coarse meshes and is relatively fluffy, while the high-density portion 26t1 at the second side of the filter 26t has denser meshes. Accordingly, in the filter 26t in the first variation, the toner collecting ability of the high-density portion 26t1 is higher than the toner collecting ability of the low-density portion 26t2. In the first variation, the ring-shaped sticker 26u attachable to a stopper 26r (serving as the pressing member and the stuck member) is disposed around the ventilation face on the second side (i.e., the upper face in FIG. 7A, the upper face of the high-density portion 26t1) in the ventilation direction of the filter 26t. Such a configuration prevents the air in the developing device 26 from being discharged to the outside of the developing device 26 together with toner without passing through the filter 26t. As illustrated in FIGS. 7A and 7B, the filter 26t in the first variation is an integrated unit in which the stopper 26r (stuck member) is attached to the sticker 26u. That is, the filter 26t and the stopper 26r, united as a single unit, are detachably attached to the developing device 26. As a result, an attaching and detaching operability of the filter 26t and the stopper 26r is enhanced together with the positional accuracy of the filter 26t with respect to the stopper 26r.

Second Variation

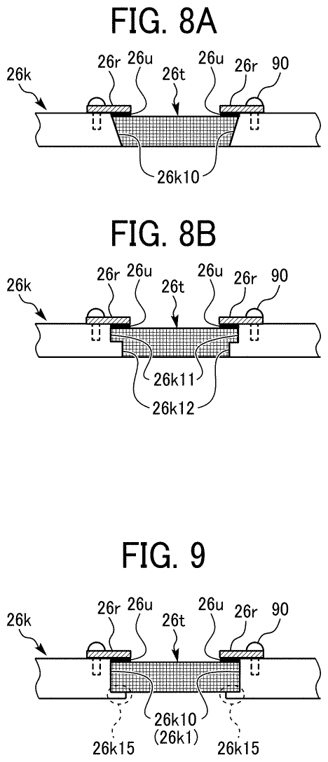

As illustrated in FIGS. 8A and 8B, in the developing device 26 in the second variation, the rim 26k10 of the opening portion 26k1 is formed such that an opening area of the opening portion 26k1 decreases from the outside of the developing device 26 toward the inside of the developing device 26. Also in the second variation, the sticker 26u is disposed on the outer rim of the upper face (as a downstream face in the ventilation direction) of the filter 26t and is attached to the stopper 26r. Specifically, in the developing device 26 illustrated in FIG. 8A, the rim 26k10 of the opening portion 26k1 is formed such that the opening area of the opening portion 26k1 continuously decreases from the outside of the developing device 26 toward the inside of the developing device 26 (downward in FIG. 8A). That is, the rim 26k10 has an inclined face that is inclined so as to be apart from the central portion of the opening portion 26k1 in the discharge direction (i.e., ventilation direction) in which the air is discharged to the outside of the developing device 26. Such a configuration of the rim 26k10 allows the low-density portion 26t2, which is easily compressed, to be compressed at a higher compression rate. Thus, the adhesion of the filter 26t to the opening portion 26k1 can be enhanced. The filter 26t is easily attached from the outside of the developing device 26 to the opening portion 26k1, whereas the filter 26t is easily removed from the developing device 26. Further, the lower end of the inclination of the rim 26k10 functions as a restricting portion that prevents the filter 26t from dropping into the developing device 26. Such a configuration also prevents the air in the developing device 26 from being discharged to the outside of the developing device 26 together with the toner without passing through the filter 26t.

On the other hand, in the developing device 26 illustrated in FIG. 8B, the rim 26k10 of the opening portion 26k1 is formed such that the opening area of the opening portion 26k1 decreases in a stepped manner from the outside of the developing device 26 toward the inside of the developing device 26 (downward in FIG. 8B). Specifically, the opening portion 26k1 having a two-stage structure includes a first rim 26k11 having a large opening area formed on the outside of the developing device 26 (upper side in FIG. 8B) and a second rim 26k12 having a small opening area on the inside of the developing device 26 (lower side in FIG. 8B). Such a configuration also prevents the air in the developing device 26 from being discharged to the outside of the developing device 26 together with the toner without passing through the filter 26t. Like the case as illustrated in FIG. 8A, the rims 26k11 and 26k12 formed such that the opening area is decreased in a stepped manner enhances the attaching and detaching operability of the filter 26t to and from the opening portion 26k1. The step between the rims 26k11 and 26k12 prevents the filter 26t from dropping in the developing device 26.

Third Variation

As illustrated in FIG. 9, the developing device 26 in the third variation includes a restricting portion 26k15 that restricts the filter 26t from dropping into the developing device 26 from the opening portion 26k1 (rim 26k10). Specifically, the restricting portion 26k15 that protrudes in a direction of narrowing the opening portion 26k1 is formed below the opening portion 26k1 (rim 26k10) of the developing case 26k. The restricting portion 26k15 contacts the first side of the filter 26t (i.e., a portion having a low weight density at the first side in the ventilation direction). Such a configuration of the restricting portion 26k15 can prevent a defect that the filter 26t disposed in the opening portion 26k1 drops inside the developing device 26. The restricting portion 26k15 also facilitates determination of a vertical position of the filter 26t in the opening portion 26k1. Also in the third variation, the sticker 26u is formed on the outer rim of the upper face (downstream side in the ventilation direction) of the filter 26t and is attached to the stopper 26r. Such a configuration also prevents the air in the developing device 26 from being discharged to the outside of the developing device 26 together with the toner without passing through the filter 26t.

As described above, the filter 26t in the present embodiment is formed such that the weight density per unit volume at the first side of the filter 26t is smaller than the weight density per unit volume at the second side of the filter 26t. The filter 26t includes the sticker 26u that can be attached to the stopper 26r (stuck member) around the face on the other end side of the filter 26t. Accordingly, a defect that air (discharge object) in the developing device 26 is discharged to the outside of the developing device 26 together with toner (collection object) can be reduced.

In the present embodiment, the process cartridge 20 does not include the developing device 26. The developing device 26 is a unit that is independently attachable to and removable from the main body of the image forming apparatus 1. Alternatively, the developing device 26 may be one of the constituent members of the process cartridge 20, and the process cartridge 20 may be configured to be integrally attached to and detached from the main body of the image forming apparatus 1. In such a configuration, similar effects to those of the above-described embodiments and variations can also be attained. It is to be noted that the term “process cartridge” used in the present disclosure is defined as a unit that unites an image bearer and at least one of a charging device to charge the image bearer, a developing device to develop a latent image on the image bearer, and a cleaning device to clean the image bearer and that is attachable to and removable from a main body of an image forming apparatus.

In the present embodiments, the developing device 26 includes the two conveying screws (i.e., the first conveying screw 26b1 and the second conveying screw 26b2) as the conveyors horizontally arranged in parallel and the doctor blade 26c disposed below the developing roller 26a. The configuration of the developing device to which the present disclosure is applied is not limited to the above-described configurations. The present disclosure may be applied to other developing devices such as a developing device in which three or more conveyors are arranged in parallel in the horizontal direction, a developing device in which multiple conveyors are arranged in parallel in the vertical direction, and a developing device in which the doctor blade is disposed above the developing roller. In the present embodiments, the present disclosure is applied to the developing device 26 that contains the two-component developer including toner and carrier. Alternatively, the present disclosure may also be applied to a developing device that contains the one-component developer (i.e., toner, which may include additives). Such cases also provide substantially the same effects as the effects described above.

In the present embodiment, the developing device 26 serves as the filter holding device. However, the filter holding device is not limited to the developing device 26. The filter holding device may be any device containing powder such as toner inside, for example, the toner containers 70, the waste-toner container 80, the cleaning devices 23, the intermediate transfer belt cleaner 81, the toner supplying devices, and the toner conveyors. Further, in the present embodiments, the present disclosure is applied to the developing device 26 as a filter holding device configured to collect toner as a collection object and discharge an air as a discharge object to the outside of the developing device 26. The filter holding device (combination of the discharge object and the collection object) to which the present disclosure is applied is not limited to this. For example, the present disclosure can be applied to the main body of the image forming apparatus 1 as a filter holding device configured to collect ozone as a collection object and discharge air as a discharge object (air not containing ozone) to the outside of the image forming apparatus 1. In the present embodiment, the sticker 26u of the filter 26t is attached to the stopper 26r as the stuck member. However, the stuck member to which the sticker 26u of the filter 26t is attached is not limited to the stuck member described above. For example, the sticker 26u of the filter 26t may be directly attached to the developing case 26k as the stuck member. Such cases also provide substantially the same effects as the effects described above.

The present embodiments are illustrative and do not limit the present disclosure. Thus, numerous additional modifications and variations are possible in light of the above teachings. It is therefore to be understood that within the scope of the present disclosure, the present disclosure may be practiced otherwise than as specifically described herein. Further, the number, position, shape, and the like, of components are not limited to those of the present embodiment, and may be the number, position, shape, and the like, that are suitable for implementing the present disclosure.

In the embodiments and variations described above, the “ring shape” is defined as a shape having an open center. For example, the “ring shape” includes a circular ring and a square ring.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. A filter comprising:
a sticker; and
a filter body,
wherein the filter body has a smaller weight density per unit volume at a first side than at a second side opposite the first side, and
wherein the sticker is disposed around a surface of the second side of the filter body.

2. The filter according to claim 1, further comprising a stuck member stuck with the sticker.

3. The filter according to claim 1,
wherein the sticker is made of a double-sided tape or an adhesive.

4. The filter according to claim 1,
wherein the filter body has a single-layer structure in which the weight density per unit volume of the filter body gradually increases in a direction from the first side to the second side.

5. The filter according to claim 1,
wherein the filter body has a two-layer structure in which a low-density portion is disposed at the first side and a high-density portion is disposed at the second side, the low-density portion having a lower weight density per unit volume than the high-density portion.

6. The filter according to claim 1,
wherein the filter body is configured to be used in a state in which the first side is located upstream in a ventilation direction and the second side is located downstream in the ventilation direction.

7. The filter according to claim 2,
wherein the stuck member is an air-impermeable member, and
wherein the filter body is an integrated unit in which the stuck member is attached to the sticker.

8. The filter according to claim 1,
wherein the sticker has a ring shape.

9. A filter holding device comprising:
an opening portion configured to communicate an inside of the filter holding device with an outside of the filter holding device, the opening portion having a rim that extends in a communication direction from the inside of the filter holding device toward the outside of the filter holding device; and
the filter according to claim 1,
wherein the filter is fitted to the rim such that the first side of the filter faces the inside of the filter holding device and the second side of the filter faces the outside of the filter holding device.

10. The filter holding device according to claim 9, further comprising a stuck member stuck with the sticker,
wherein the stuck member is detachably attached to the filter holding device.

11. The filter holding device according to claim 9, further comprising a restricting portion configured to restrict the filter from dropping from the opening portion into the inside of the filter holding device.

12. The filter holding device according to claim 11,
wherein the restricting portion is in contact with the first side of the filter.

13. A developing device configured to contain toner inside to develop a latent image formed on a surface of an image bearer, the developing device comprising the filter holding device according to claim 9.

14. A process cartridge configured to be detachably attached to an image forming apparatus, the process cartridge comprising:
the developing device according to claim 13; and
the image bearer.

15. An image forming apparatus comprising the process cartridge according to claim 14.

16. An image forming apparatus comprising the developing device according to claim 13.

17. An image forming apparatus comprising the filter holding device according to claim 9.

18. An image forming apparatus comprising the filter according to claim 1.
